(19) United States
(12) Patent Application Publication
(10) Pub. No.: US 2022/0036569 A1
(43) Pub. Date: Feb. 3, 2022

(54) METHOD FOR TRACKING IMAGE OBJECTS

(71) Applicant: NADI SYSTEM CORP., Taipei City (TW)

(72) Inventor: SYUAN-PEI CHANG, Taipei City (TW)

(73) Assignee: NADI SYSTEM CORP., Taipei City (TW)

(21) Appl. No.: 17/389,458

(22) Filed: Jul. 30, 2021

(30) Foreign Application Priority Data
Jul. 30, 2020 (TW) 109125789

(51) Int. Cl. G06T 7/292; G06T 7/187; H04N 5/232; G06T 7/00

(52) U.S. Cl. CPC G06T 7/292; G06T 7/187; G06T 2207/10004; G06T 7/97; H04N 5/23299

(57) ABSTRACT

The present invention provides a method for tracking image objects, adopting at least one first camera and at least one second camera, wherein the first camera shoots a physical environment to obtain a first image, and the second camera shoots the physical environment to obtain a second image that partially overlaps the first image The method comprises the steps of: (a) merging the first image with the second image, in order to form a composite image; and (b) framing and tracking at least one object of the composite image.

### BACKGROUND OF THE INVENTION

### 1. Field of the Invention

The present invention generally relates to a method for tracking image objects, more particularly to a method for merging images to track image objects.

### 2. Description of the Prior Art

Presently, since labor costs continuously increasing in labor costs, more people tend to use image monitoring systems for security, in order to obtain the most comprehensive protections but with very limited human resources. There are conditions with public environmental safety, for examples as department stores, supermarkets, airports, the image monitoring systems have been applied for a long time. An image monitoring system is usually equipped with multiple cameras, and the image captured by each camera is displayed on the display screen simultaneously or time-sharing to achieve the purpose of monitoring many locations, such as lobby entrances, parking lots, etc., at the same time. On the other side, to install an image monitoring system in a large area, in addition to the need for a considerable number of cameras, inconvenience to the monitoring personnel will be caused in the screen monitoring, and the monitoring personnel is not able to fully view and perform complete monitoring.

Due to the information technology going very well, computer is the main role to execute the monitoring works. There is an important problem that is continuously happening, that is, to ask computer to determine whether an object and a human figure in different cameras are the same or not is very hard, since it may need more algorithms and calculation resources, but misjudgments happen all the time. Therefore, how to figure out this problem is worth considering for those people who are skilled in the art.

### SUMMARY OF THE INVENTION

The main objective of the present invention provides a method for tracking image objects. The present invention is able to precisely judge whether an object and a human figure in different cameras are the same or not.

The method for tracking image objects of the present invention is applicable for at least one first camera and at least one second camera. The first camera shoots a physical environment to obtain a first image, and the second camera shoots the physical environment to obtain a second image that partially overlaps the first image. The method for tracking image objects has the steps of: (a) merging the first image with the second image, in order to form a composite image; and (b) framing and tracking at least one object of the composite image.

The method for tracking the image objects further has the steps of: (c) building up a three-dimensional space model that corresponds to the actual environment; (d) using a height, a shooting angle and a focal length of the first camera to build up a corresponding first view cone model, and determining a first shooting coverage area where the first camera is in the physical environment based on the first view cone model; (e) using a height, a shooting angle and a focal length of the second camera to build up a corresponding second view cone model, and determining a second shooting coverage area where the second camera is in the physical environment based on the second cone model; (f) searching a first virtual coverage area that corresponds to the first shooting coverage area in the three-dimensional space model; (g) searching a second virtual coverage area that corresponds to the second shooting coverage area in the three-dimensional space model; (h) integrating the first virtual coverage area with the second virtual coverage area to form a third virtual coverage area; and (i) introducing the composite image to the three-dimensional space model, and projecting the composite image to the third virtual coverage area.

Preferably, the first image being merged with the second image is through an image stitching algorithm that has an SIFT algorithm.

Preferably, framing and tracking the at least one object of the composite image is through an image analysis module that has a neural network model.

Preferably, the neural network model is to execute deep learning algorithms.

Preferably, the neural network model is a convolutional neural network model.

Preferably, the convolutional neural network model is VGG model, ResNet model or DenseNet model.

Preferably, the neural network model is YOLO model, CTPN model, EAST model, or RCNN model.

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1A illustrates a flow chart of a preferred embodiment of a method for tracking image objects of the present invention;

FIG. 1B illustrates a schematic plan view of a first partial area 80 of a physical environment 8 of the present invention;

FIG. 1C illustrates schematic plan view of a first partial area 80 of a physical environment 8 of the present invention, and a schematic three-dimensional view of the first partial area 80 of a first camera 12A and a second camera 12B shooting in the physical environment of the present invention;

FIG. 2A illustrates a schematic view of a composite image 320 of the present invention;

FIG. 2B illustrates a schematic view of framing a human figure of the present invention;

FIG. 3A illustrates a schematic plan view of a three-dimensional space model 131 of the present invention;

FIG. 3B illustrates a schematic three-dimensional view of a second partial area 1310 of the three-dimensional space model 131 of the present invention;

FIG. 4A illustrates a schematic view of the first camera 12A and a first view cone model 141A of the present invention;

FIG. 4B illustrates a schematic view of the second camera 12B and a second view cone model 141B of the present invention;

FIG. 5A illustrates a schematic view of a first virtual coverage area 131A located in the second partial area 1310 of the present invention;

FIG. 5B illustrates a schematic view of a second virtual coverage area 131B located in the second partial area 1310 of the present invention; and

FIG. 5C illustrates a schematic view of a third virtual coverage area 131C located in the second partial area 1310 of the present invention.

FIG. 6 illustrates a schematic view of the composite image 320 projected in the third virtual coverage area 131C.

### DETAILED DESCRIPTION OF THE INVENTION

Following preferred embodiments and figures will be described in detail so as to achieve aforesaid objects.

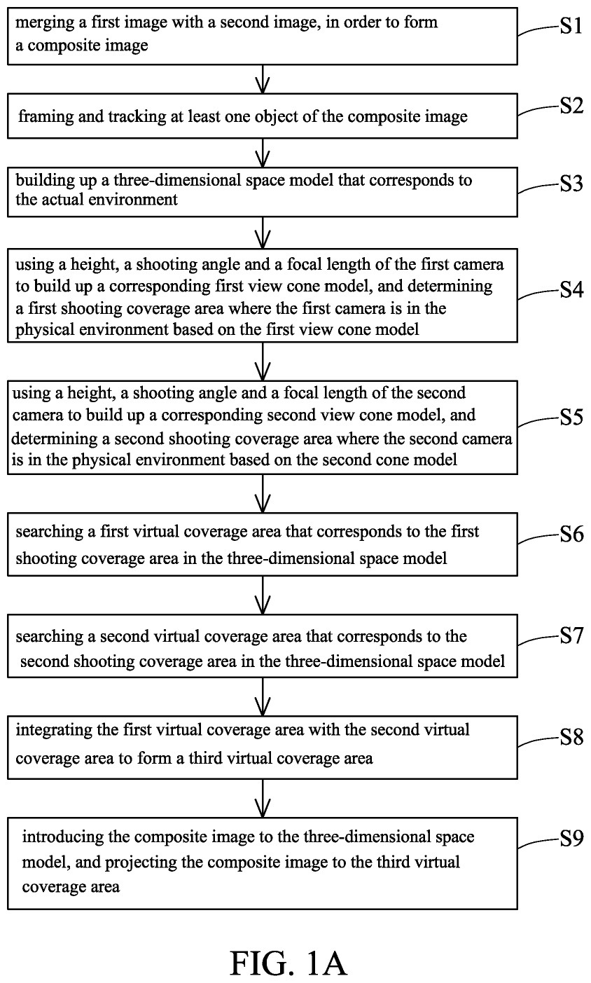

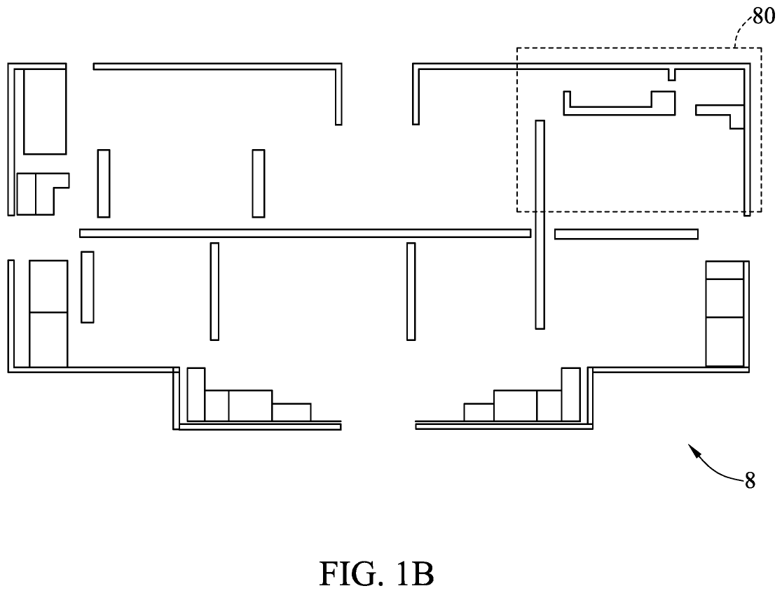

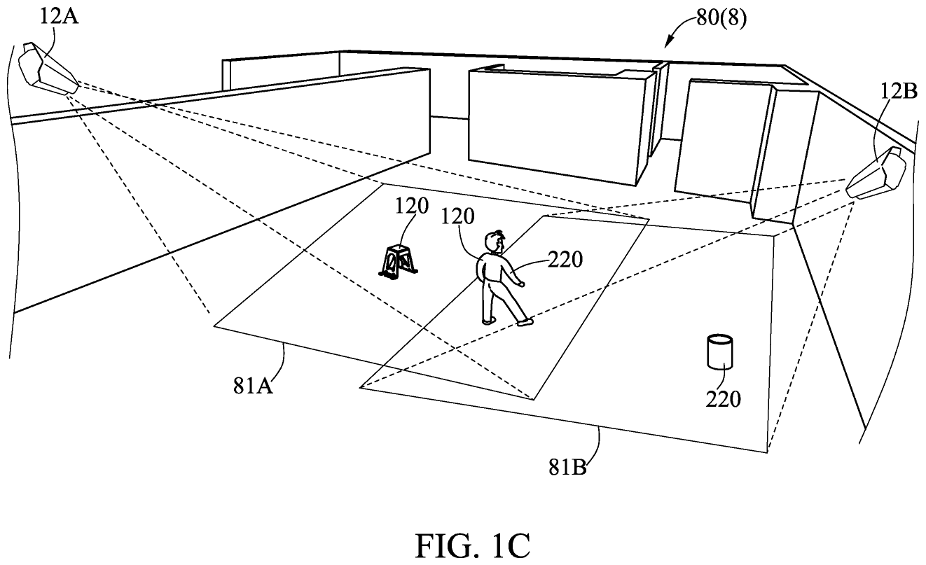

Please refer to FIG. 1A, FIG. 1B and FIG. 1C, which illustrate a flow chart of a preferred embodiment of a method for tracking image objects of the present invention, a schematic plan view of a first partial area 80 of a physical environment 8 of the present invention, and a schematic three-dimensional view of the first partial area 80 of a first camera 12A and a second camera 12B shooting in the physical environment of the present invention.

The method for tracking image objects of the present invention is applicable for the at least one first camera 12A and the at least one second camera 12B. The first camera 12A shoots the first partial area 80 of the physical environment 8 to obtain a first image 120, and the first image 120 is an example of a chair and a human figure. Similarly, the second camera 12B shoots the first partial area 80 of the physical environment to obtain a second image 220 that is an example of the human figure and a trash can. The first image 120 and the second image 220 are partially overlapped. As it can be seen, the human figure in FIG. 1C is an image that is overlapped by the first image 120 and the second image 220.

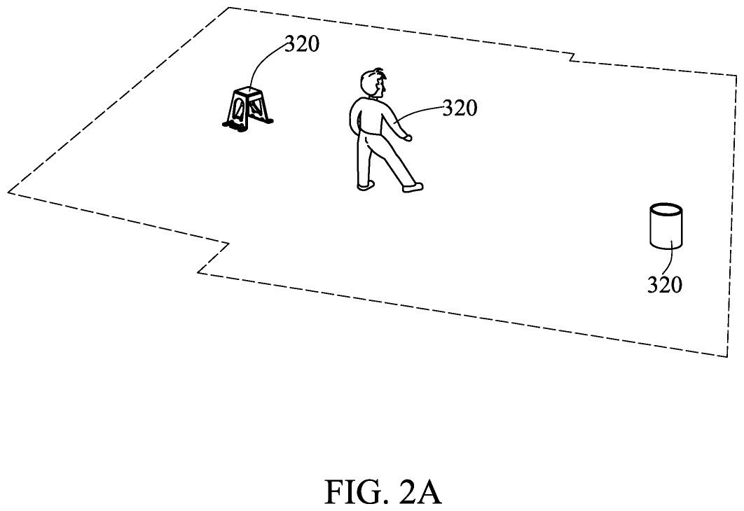

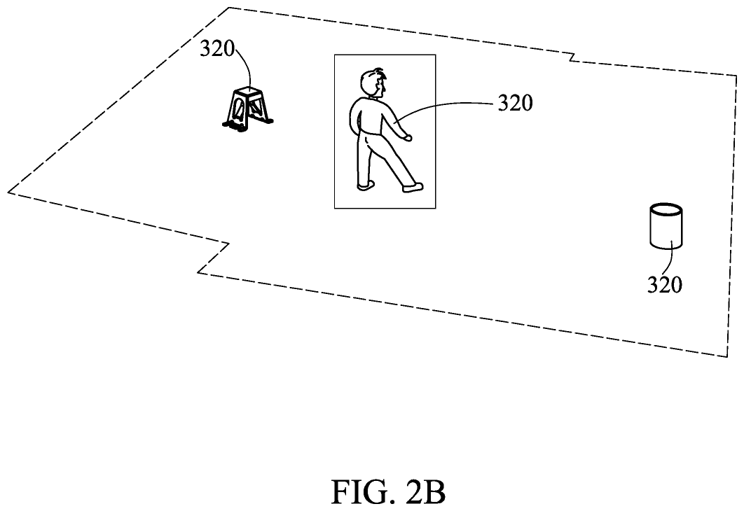

With reference to FIG. 2A and the step (S1) in FIG. 1A, FIG. 2A shows a schematic view of a composite image 320 of the present invention. The step (S1) is to merge the first image 120 with the second image 220 in order to form the composite image 320 via an SIFT algorithm, which is fully named as scale-invariant feature transform algorithm.

Please refer to FIG. 2B and the step (S2) in FIG. 1A, FIG. 2B shows a schematic view of framing the human figure of the present invention. The step (S2) is to frame and track at least one object of the composite image 320. The composite image 320 has three objects having a chair, the human figure and the trash can. The human figure is a moveable member, thus it is mainly an object to be framed and tracked. Accordingly, framing and tracking at least one object of the composite image 320 is through an image analysis module that has a neural network model, and the neural network model is to execute deep learning algorithms. As a matter of fact, the neural network model is a convolutional neural network model, a YOLO model, a CTPN model, an EAST model, or an RCNN model. Further, the convolutional neural network model is a VGG model, a ResNet model or a DenseNet model.

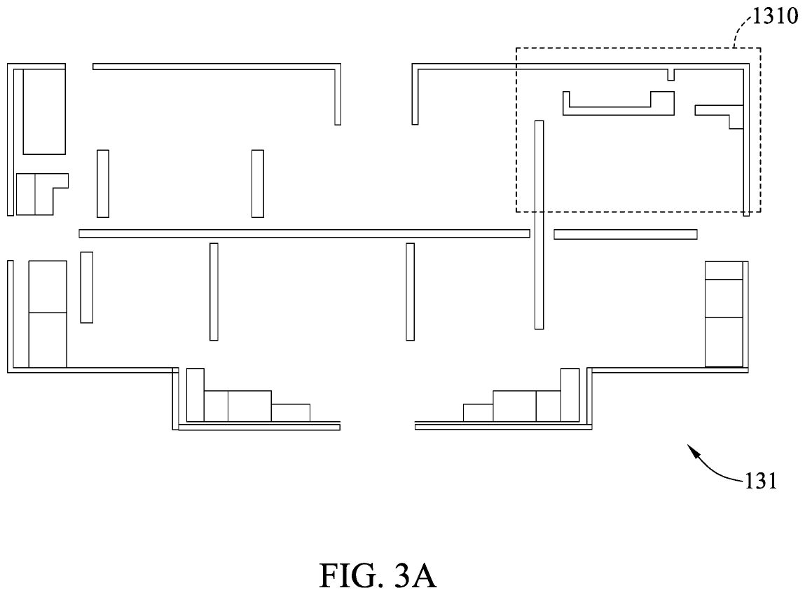

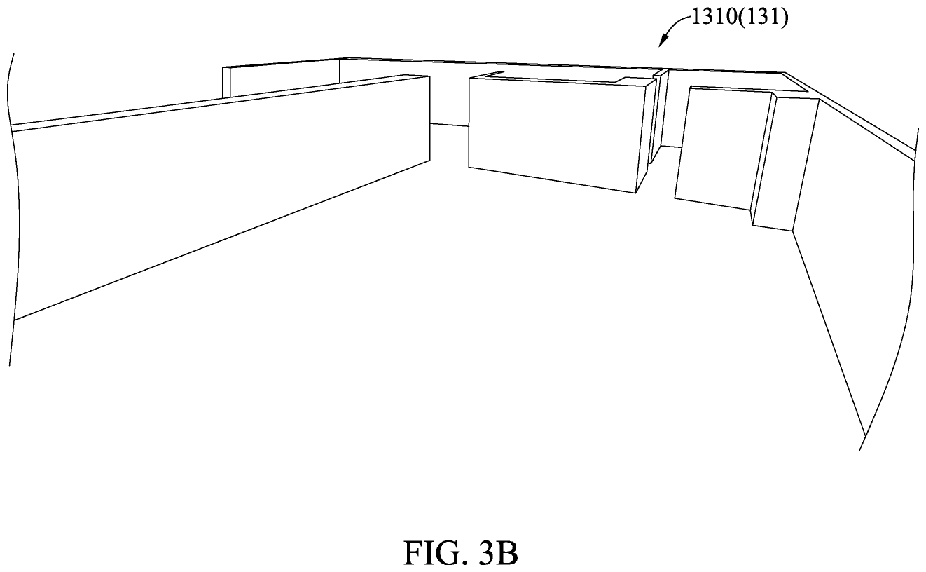

With reference to FIG. 3A, FIG. 3B and the step (S3) in FIG. 1A, FIG. 3A shows a schematic plan view of a three-dimensional space model 131 of the present invention, a schematic three-dimensional view of a second partial area 1310 of the three-dimensional space model 131 of the present invention. The step (S3) is to build up the three-dimensional space model 131 that has the second partial area 1310. The three-dimensional space model 131 corresponds to the physical environment 8, and the first partial area 80 of the physical environment 8 corresponds to the second partial area 1310. Specifically, the three-dimensional space model 131 is a three-dimensional environment simulation view of the first partial area 80, therefore the rations of every building are imitated in the physical environment 8.

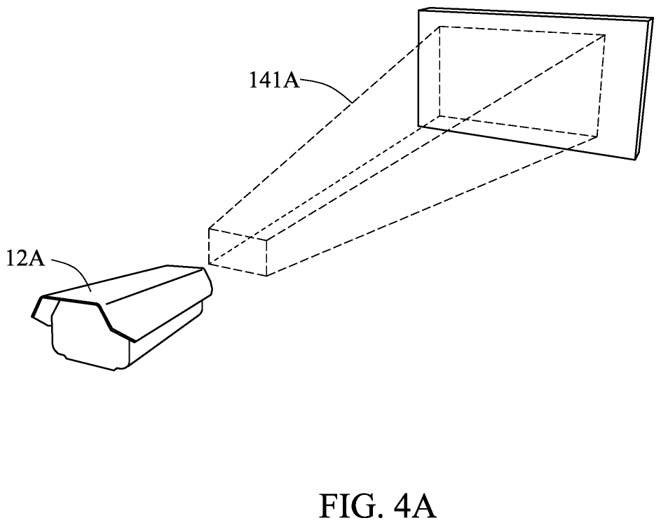

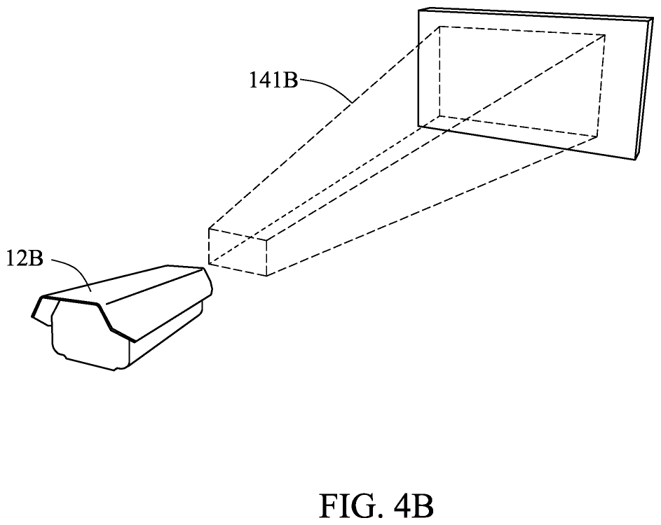

Please refer to FIG. 1C, FIG. 4A and the step (S4) in FIG. 1A, FIG. 4A shows a schematic view of the first camera 12A and a first view cone model 141A of the present invention. The step (S4) is to use a height, a shooting angle and a focal length of the first camera 12A to build up the corresponding first view cone model 141A, and determine a first shooting coverage area 81A where the first camera 12A is in the physical environment 8 based on the first view cone model 141A. The first view cone model 141A may produce different figures via a perspective projection and a parallel projection. As an example, the first view cone model 141A in FIG. 4A is similar to a trapezoid. As a matter of fact, the first shooting coverage area 81A is defined as a field of view for the first camera 12A shooting in the physical environment 8.

Please see FIG. 1C, FIG. 4B and the step (S5) in FIG. 1A, FIG. 4B shows a schematic view of the second camera 12B and a second view cone model 141B of the present invention. The step (S5) is to use a height, a shooting angle and a focal length of the second camera 12B to build up the corresponding second view cone model 141B, and determine a second shooting coverage area 81B where the second camera 12B is in the physical environment 8 based on the second view cone model 141B. As a matter of fact, the second shooting coverage area 81B is defined as a field of view for the second camera 12B shooting in the physical environment 8.

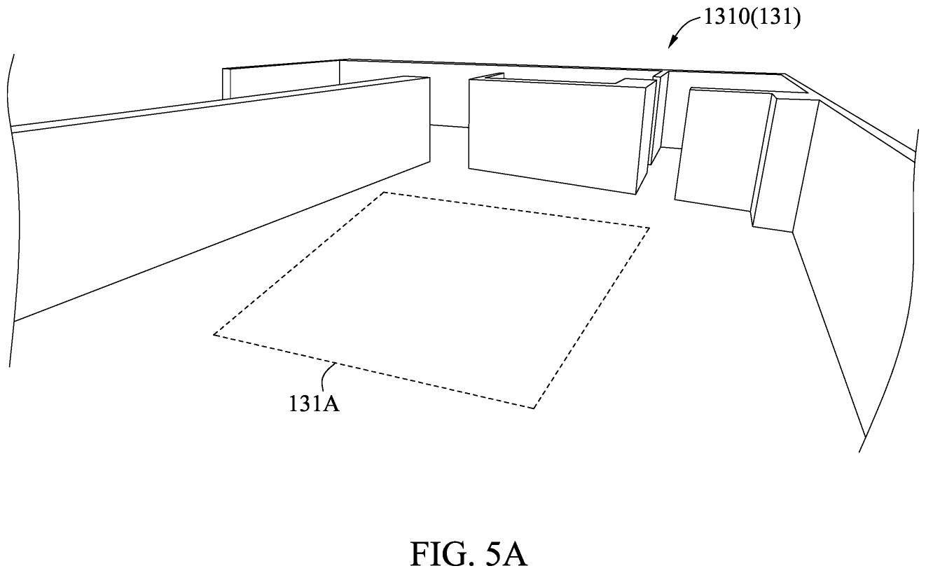

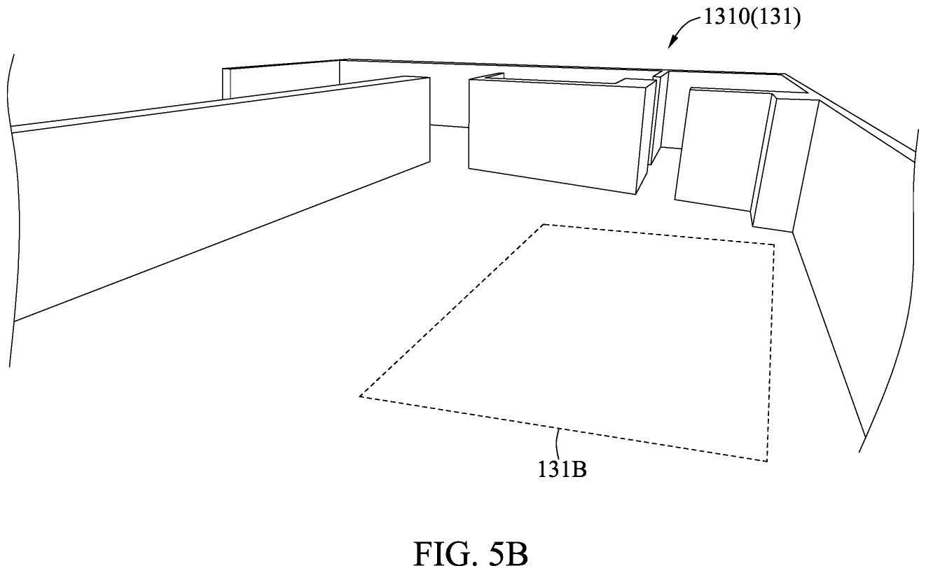

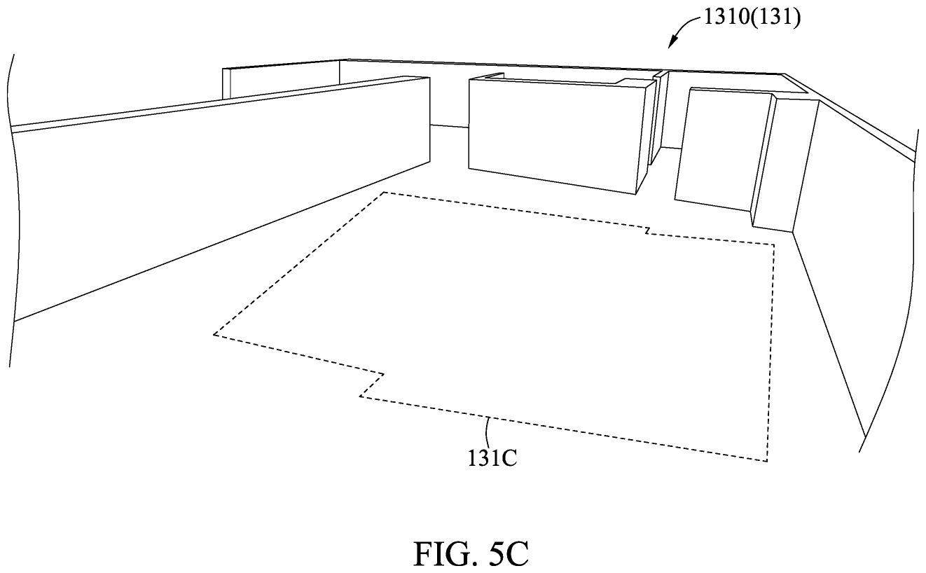

Please refer to FIG. 5A and the step (S6) in FIG. 1A, FIG. 5A illustrates a schematic view of a first virtual coverage area 131A located in the second partial area 1310 of the present invention. The step (S6) is to search the first virtual coverage area 131A that corresponds to the first shooting coverage area 81A in the three-dimensional space model 131.

Please refer to FIG. 5B and the step (S7) in FIG. 1A, FIG. 5B illustrates a schematic view of a second virtual coverage area 131B located in the second partial area 1310 of the present invention. The step (S7) is to search the second virtual coverage area 131B that corresponds to the second shooting coverage area 81B in the three-dimensional space model 131.

Please refer to FIG. 5C and the step (S8) in FIG. 1A, FIG. 5C illustrates a schematic view of a third virtual coverage area 131C located in the second partial area 1310 of the present invention. The step (S8) is to integrate the first virtual coverage area 131A with the second virtual coverage area 131B to form a third virtual coverage area 131C.

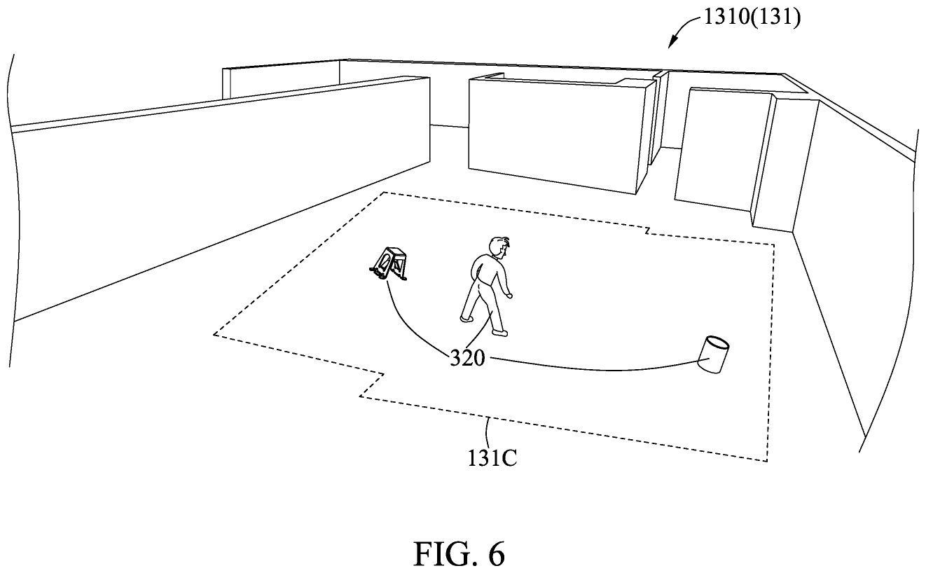

With reference to FIG. 6 and the step (S9) in FIG. 1A, FIG. 6 illustrates a schematic view of the composite image 320 projected in the third virtual coverage area 131C. The step (S9) is to introduce the composite image 320 to the three-dimensional space model 131, and project the composite image 320 to the third virtual coverage area 131C. Hence, the chair, the human figure and the trash can are all projected on the surface of the third virtual coverage area 131C.

Compared to traditional tracking methods and according to the step (S1) to the step (S9), the present invention integrates the single composite image 320 from different images obtained by different cameras. The composite image 320 is thus projected in the third virtual coverage area 131C of the three-dimensional space model 131. Since computer does not determine whether an object and a human figure in different cameras are the same or not, so as to speed up for framing and tracking objects.

As aforesaid, the present invention is able to precisely judge whether an object and a human figure in different cameras are the same or not.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims

What is claimed is:

1. A method for tracking image objects, adopting at least one first camera and at least one second camera, wherein the first camera shoots a physical environment to obtain a first image, and the second camera shoots the physical environment to obtain a second image that partially overlaps the first image, comprising the steps of:
(a) merging the first image with the second image, in order to form a composite image; and
(b) framing and tracking at least one object of the composite image.

2. The method for tracking the image objects according to claim 1 further comprising the steps of:
(c) building up a three-dimensional space model that corresponds to the actual environment;
(d) using a height, a shooting angle and a focal length of the first camera to build up a corresponding first view cone model, and determining a first shooting coverage area where the first camera is in the physical environment based on the first view cone model;
(e) using a height, a shooting angle and a focal length of the second camera to build up a corresponding second view cone model, and determining a second shooting coverage area where the second camera is in the physical environment based on the second cone model;
(f) searching a first virtual coverage area that corresponds to the first shooting coverage area in the three-dimensional space model;
(g) searching a second virtual coverage area that corresponds to the second shooting coverage area in the three-dimensional space model;
(h) integrating the first virtual coverage area with the second virtual coverage area to form a third virtual coverage area; and
(i) introducing the composite image to the three-dimensional space model, and projecting the composite image to the third virtual coverage area.

3. The method for tracking the image objects according to claim 1, wherein the first image being merged with the second image in step (a) is through an image stitching algorithm that has an SIFT algorithm.

4. The method for tracking the image objects according to claim 1, wherein framing and tracking the at least one object of the composite image in step (b) is through an image analysis module that has a neural network model.

5. The method for tracking the image objects according to claim 4, wherein the neural network model is to execute deep learning algorithms.

6. The method for tracking the image objects according to claim 4, wherein the neural network model is a convolutional neural network model.

7. The method for tracking the image objects according to claim 5, wherein the convolutional neural network model is selected from the group consisting of: VGG model, ResNet model and DenseNet model.

8. The method for tracking the image objects according to claim 4, wherein the neural network model is selected from the group consisting of: YOLO model, CTPN model, EAST model, and RCNN model.
